(19) United States
(12) Patent Application Publication
(10) Pub. No.: US 2010/0239404 A1
(43) Pub. Date: Sep. 23, 2010

(54) STORAGE AND DEPLOYMENT SYSTEM

(76) Inventors: Bert Joseph Blanchard, St. Martinville, LA (US); Philip John O'Connor, Youngsville, LA (US)

Correspondence Address: PATTERSON & SHERIDAN, L.L.P., 3040 POST OAK BOULEVARD, SUITE 1500, HOUSTON, TX, 77056, US

(21) Appl. No.: 12/409,321

(22) Filed: Mar. 23, 2009

(51) Int. Cl. E21B 19/00; B65G 65/00; E21B 19/14

(52) U.S. Cl. 414/680; 414/800

(57) ABSTRACT

The present invention generally relates to an apparatus and method for handling wellbore tools. In one aspect, a method of placing wellbore tools at a wellsite is provided. The method includes the step of providing a storage and deployment system at the wellsite. The method further includes the step of loading the wellbore tools in a basket. The method also includes the step of placing the basket loaded with the wellbore tools on the storage and deployment system. Further, the method includes the step of moving the basket with the wellbore tools from a loading position to a deployment position. Additionally, the method includes the step of removing one of the wellbore tools from the basket and positioning the wellbore tool for deployment into a wellbore. In another aspect, a storage and deployment system for loading or unloading wellbore tools at a wellsite is provided. In yet a further aspect, a method of removing wellbore tools at a wellsite is provided.

### BACKGROUND OF THE INVENTION

1. Field of the Invention

Embodiments of the present invention generally relate to handling wellbore tools. More particularly, embodiments of the present invention relate to a storage and deployment system.

2. Description of the Related Art

Tubulars are used on an offshore production facility during a well intervention operation. These tubulars must be transported from a pipe yard to the offshore production facility prior to the well intervention operation. The conventional tubular transportation process starts at the pipe yard where the tubulars are sorted by size, weight, grade and connection type. Next, the tubulars are loaded on trucks using fork trucks (or cranes) with slings. Once loaded on the trucks, the trucks transport the tubulars to the shipping docks where the tubulars can be offloaded onto a supply ship. If the tubulars have not already been bundled together at the pipe yard, the tubulars will be organized so that the tubulars can be loaded onto the supply ship. The supply ship then transports the tubulars to the offshore production facility. When the supply ship gets to the offshore production facility, the tubulars are offloaded again onto the offshore production facility. Thereafter, the tubulars must be properly positioned on the offshore production facility so that the tubulars may be deployed during the well intervention operation.

During the conventional tubular transportation process, the tubulars are handled a minimum of four times. Each time the tubulars are handled, the people handling the tubulars are placed at risk of injury. Further, each time the tubulars are handled, the equipment used to move the tubulars and the tubulars themselves are placed at risk of damage. Therefore, there is a need for an apparatus and method for transporting tubulars to an offshore production facility in a safe and efficient manner. Further, there is a need for an apparatus and method for positioning the tubular on the offshore production facility for deployment into the wellbore.

### SUMMARY OF THE INVENTION

The present invention generally relates to an apparatus and method for handling wellbore tools. In one aspect, a method of placing wellbore tools at a wellsite is provided. The method includes the step of providing a storage and deployment system at the wellsite. The method further includes the step of loading the wellbore tools in a basket. The method also includes the step of placing the basket loaded with the wellbore tools on the storage and deployment system. Further, the method includes the step of moving the basket with the wellbore tools from a loading position to a deployment position. Additionally, the method includes the step of removing one of the wellbore tools from the basket and positioning the wellbore tool for deployment into a wellbore.

In another aspect, a storage and deployment system for loading or unloading wellbore tools at a wellsite is provided. The system includes a rack base and a carrier pivotably mounted to the rack base. The system further includes a basket configured to hold the wellbore tools, wherein the basket is operatively coupled to the carrier for movement therewith. Additionally, the system includes a lifting member configured to remove the wellbore tools from the basket.

In yet a further aspect, a method of removing wellbore tools at a wellsite is provided. The method includes the step of providing a storage and deployment system at the wellsite. Further, the method includes the step of placing a basket on the storage and deployment system. The method also includes the step of moving the basket from a loading position to a deployment position. The method further includes the step of removing at least one wellbore tool from a wellbore and placing the wellbore tool in the basket. Furthermore, the method includes the step of moving the basket from the deployment position to the loading position. Additionally, the method includes the step of removing the basket with the at least one wellbore tool from the storage and deployment system.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a view illustrating a basket being loaded on a carrier of a deployment system.

FIG. 2 is a view illustrating the basket in a loading position.

FIG. 2A is a sectional view illustrating the basket.

FIG. 3 is a top view of the deployment system.

FIG. 4 is a view illustrating the basket in a deployment position.

FIG. 5 is a view illustrating a tubular being removed from the basket.

FIGS. 6A and 6B illustrate a deployment system with two carriers.

FIG. 7 illustrate a deployment system with one carrier positioned perpendicular to another carrier.

### DETAILED DESCRIPTION

The present invention generally relates to an apparatus and method for handling tubulars from a pipe yard to a wellsite. The invention will be described in relation to an offshore wellsite, however it is to be noted that the invention may also be applied to onshore wellsite without departing from principles of the present invention. To better understand the novelty of the system of the present invention and the methods of use thereof, reference is hereafter made to the accompanying drawings.

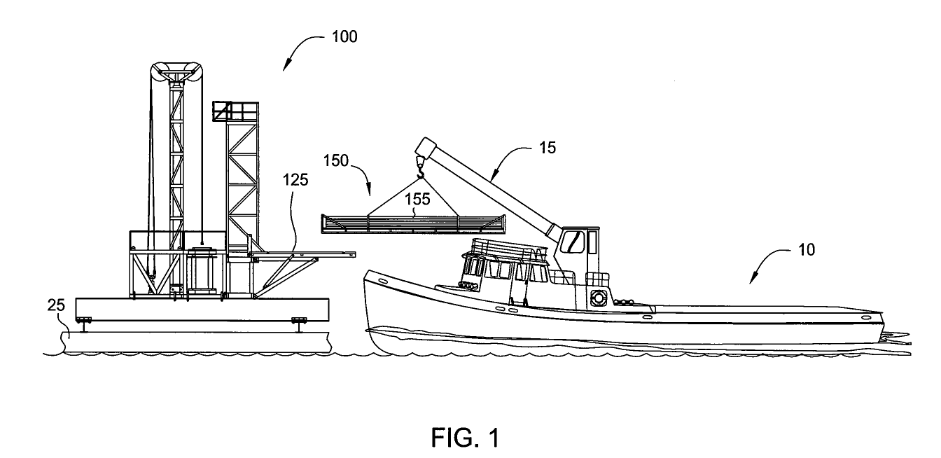

FIG. 1 is a view illustrating a basket 150 being loaded on a carrier 125 of a storage and deployment system 100. The basket 150 is configured to support a plurality of tubulars 155, such as drill pipe, tubing and/or casing. Generally, the basket 150 is loaded at a pipe yard (not shown) by placing each tubular 155 into the basket 150. The basket 150 with the tubulars 155 are then transported and loaded on a vessel 10. The vessel 10 transports the basket 150 to an offshore production structure 25 at the wellsite. Thereafter, a crane 15 on the vessel 10 places the basket 150 on the carrier 125 of the system 100. Although the system 100 in FIG. 1 shows one basket 150 being loaded, any number of baskets 150 may loaded on the system 100, without departing from principles of the present invention. Further, as will be described herein, the system 100 manipulates the position of the basket 150 such that the tubulars 155 may be removed from the basket 150.

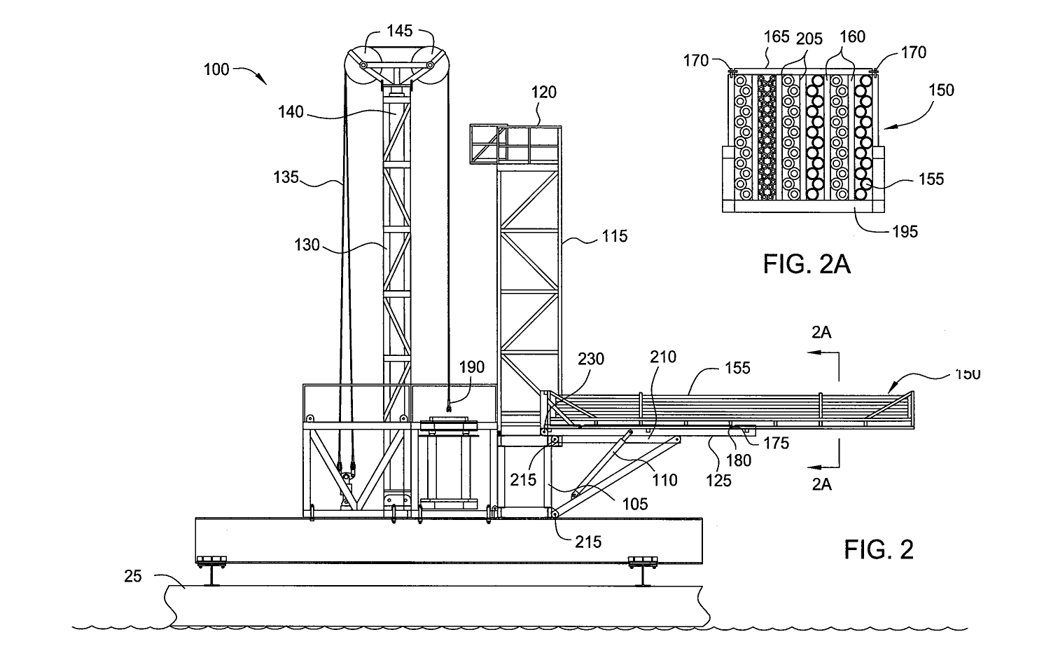

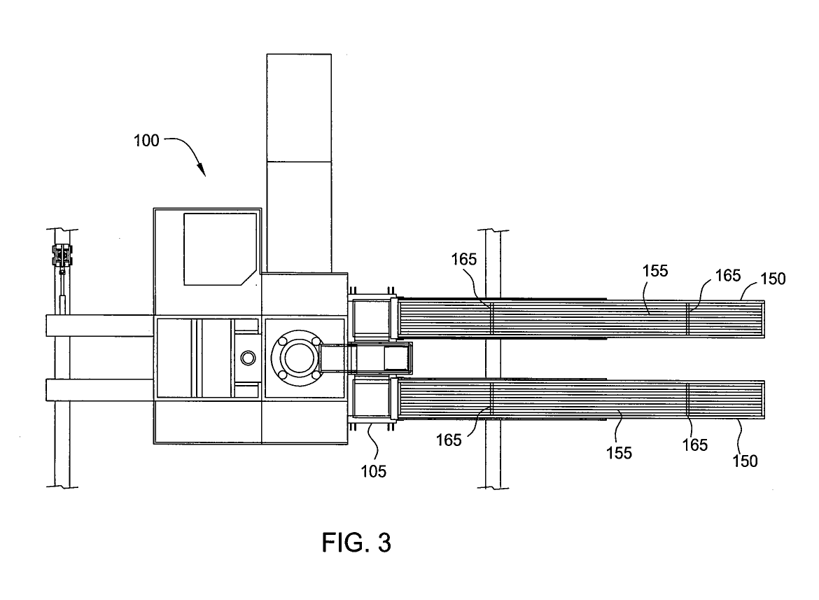

FIG. 2 is a view illustrating the basket 150 in the system 100. The basket 150 is placed on the carrier 125 by positioning pins 175 on the basket 150 within slots 180 on the carrier 125. After the pins 175 of the basket 150 are secured within the slots 180 on the carrier 125, the crane 15 releases the basket 150 and the carrier 125 fully supports the weight of the basket 150 (and tubulars). In another embodiment, the carrier 125 has a connection member, such as a pin and basket 150 has a corresponding connection member, such as a slot, wherein the connection member on the carrier 125 mates with the corresponding connection member on the basket 150 as the basket 150 is placed on the carrier 125. It should be noted that the connection member and corresponding connection member may be any type of connection arrangement that facilitates the connection of one component to another component.

As shown in FIG. 2, a carrier support 210 is attached to a rack base 105 via pins 215. Further, the carrier 125 is attached to the rack base 105 via pins 220. It is to be noted that the carrier 125 and the carrier support 210 may be detached from the rack base 105 by removing the pins 215, 220. The carrier 125 and the carrier support 210 may then positioned at another location on the rack base 105 and attached to the rack base 105 by reinstalling the pins 215, 220.

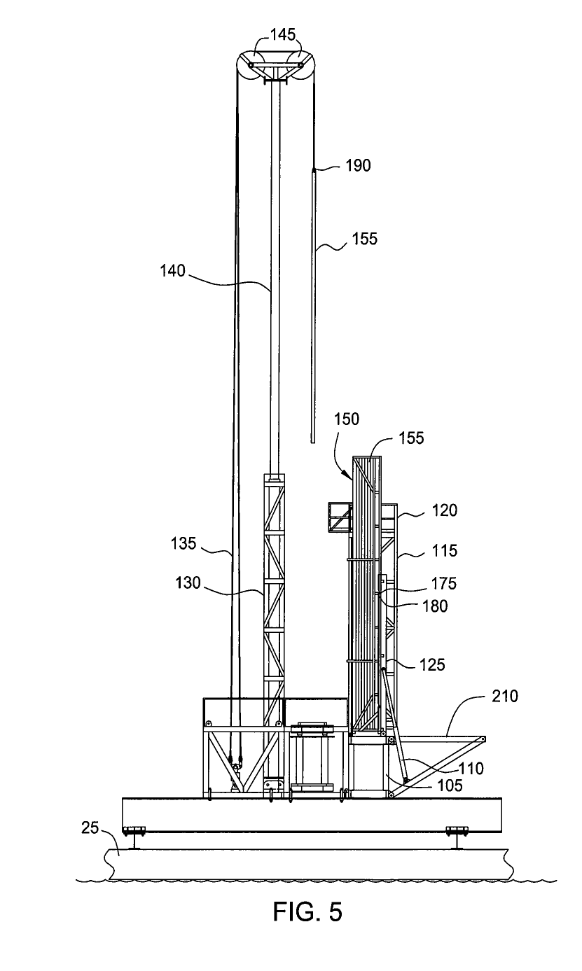

The system 100 also includes a cylinder member 110 attached between the carrier 125 and the carrier support 210. The cylinder member 110 is used to manipulate the carrier 125 such that the basket 150 is rotated around the pins 215 between a loading position, as shown in FIG. 2, and a deployment position (see FIG. 4). The cylinder member 110 may be a hydraulic cylinder or a pneumatic cylinder. Further, the cylinder member 110 may be controlled via a manual switch or via remote actuation. Additionally, the basket 150 may be optionally locked in the deployment position by a lock arrangement (not shown). In one embodiment, the lock arrangement may be part of the hydraulic (or pneumatic) system connected to the cylinder member 110. In another embodiment, the lock arrangement may be a mechanical connection, such as a pin member or any other lock arrangement that is configured to ensure the basket 150 remains in the deployment position until the basket 150 is ready to be moved back to the loading position.

The system 100 may include a first mast 115 with a support platform 120. The support platform 120 may be used by an operator during the tubular deployment (or removal) operation. For instance, the operator may stand on the support platform 120 while the tubulars 155 are being removed from the basket 150 during the tubular deployment operation. The system 100 may also include a second mast 130 with a lifting cylinder 140. Pulleys 145 are disposed at an end of the lifting cylinder 140. The pulleys are used in conjunction with a lifting cable 135 having a gripping member 190. Further, the lifting cylinder 140 may be any type of extendable/retractable cylinder, such as hydraulic cylinder or a pneumatic cylinder. Additionally, the lifting cylinder 140 may be controlled manually or via remote actuation. In one embodiment, a traveling block may be used to remove the tubulars 155 from the basket 150.

FIG. 2A is a sectional view illustrating the basket 150. The basket 150 includes a plurality of support members 160 arranged to define one or more sections 205 of the basket 150 for use in storing the tubulars 155. In one embodiment, the support members 160 are connected to a bottom support 195. As shown in FIG. 2A, each section 205 of the basket 150 may be configured to store a different size tubular. This may be useful when different size tubulars are required within the wellbore. In another embodiment, each section 205 may be configured to store other equipment along with (or without) the tubulars 155 that may be used at the wellsite, such as tools or completion items. For instance, the ability of the basket 150 to handle different sized objects may be useful to transport, deploy and remove wellbore components such as packers, pumps, screens, setting tools, bridge plugs, mills, casing cutters, fishing tools, scrapers, measurement while drilling tools, whipstock assemblies, etc. Since these type of components are usually attached to joints of tubing (or drill pipe) they may be handled in a similar manner as regular tubulars.

The tubulars 155 or equipment may be retained within each section 205 by an end bar assembly 165. In one embodiment, the end bar assembly 165 includes plates on each end with a hole that is configured to fit around a portion of the support members 160 as shown in FIG. 2A. After the end bar assembly 165 is positioned on the support members 160, pins 170 may be used at each end to lock the bar assembly 165 to the support members 160. Further, the support members 160 and the bottom supports 160 are configured such that the basket 150 may be stacked on another basket 150. This arrangement may be useful while transporting the baskets 150 to and from the offshore production structure 25.

In one embodiment, the support members 160 are connected to the bottom support 195 via a hinge member (not shown). In this arrangement, the support members 160 may rotate between a first position and a second position relative to the bottom support 195. The movement of the support members 160 may be useful to access the tubulars 155 in different sections 205 of the basket 150 after the tubulars 155 in one section have been removed. In other words, after the tubulars 155 are removed from one section 205 of the basket 150, the support member 160 defining a portion of that section 205 may be rotated from the first position to the second position such that the support member 160 is substantially parallel with a longitudinal axis of the basket 150. With the support member 160 in the second position, the tubulars 155 in the next section 205 may be removed from the basket 150.

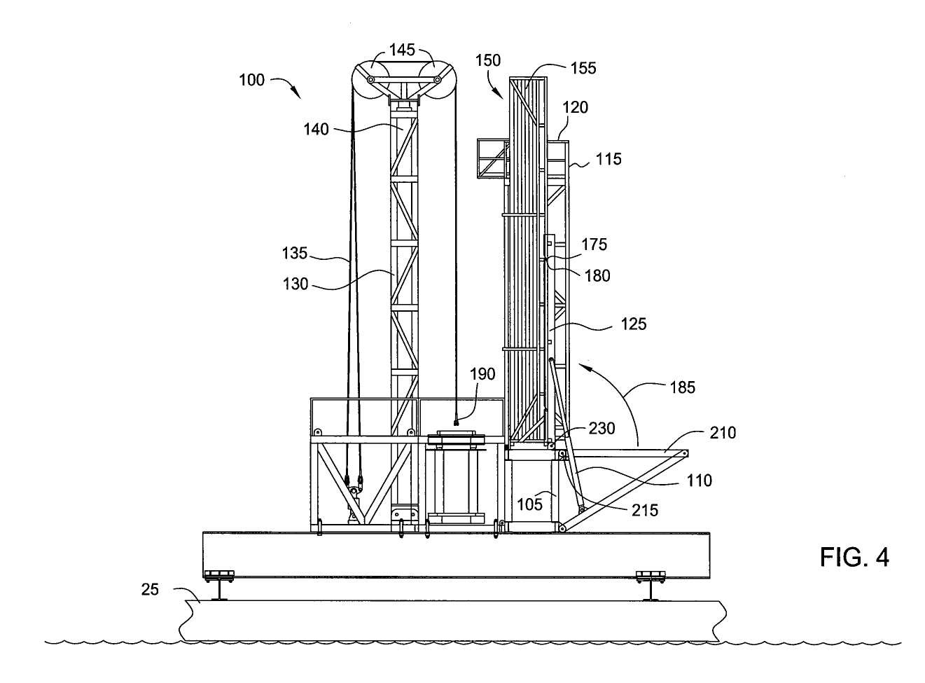

FIG. 3 is a top view of the system 100. As shown, system 100 may support two baskets 150 simultaneously in a parallel configuration. Having two baskets 150 allows the system 100 the capability of always having a full basket ready during the tubular deployment operation. For instance, a first basket may be in the deployment position and second basket may be in the loading position. After the tubulars have been removed from the first basket, the empty first basket may be moved to the loading position while at the same time the second basket may be moved to the deployment position for unloading the tubulars. While the tubulars are being deployed from the second basket, the empty first basket may be removed from the carrier 125 and replaced with a full basket. This synchronized movement of the first basket and the second basket between the loading position and the deployment position allows the system 100 to have at least one basket loaded with tubulars ready for deployment during the tubular deployment operation. In another embodiment, the baskets 150 may be loaded on the carriers 125 at the same time or at different times and may be moved to (or from) the deployment position together or separately. In other words, the loading of the baskets 150 on the carriers 125 and the movement of the baskets 150 to (or from) the deployment position may have any number of different operating sequences without departing from the principles of the present invention.

The system 100 may also be used to remove the tubulars from the wellbore. As the tubulars are removed from the wellbore during the tubular removal operation, the tubulars are placed in the basket 150. Having two baskets 150 allows the system 100 the capability of to have a basket ready for tubular removal from the wellbore. For instance, a first empty basket may be in the deployment position and the second basket may be in the loading position. After the tubulars have been placed in the first basket, the first basket may be moved to the loading position to allow the first basket to be unloaded from the carrier 125 and replaced with an empty basket. At the same time, the second basket may be moved from the loading position to the deployment position for receiving the tubulars that are removed from the wellbore. This synchronized movement of the first basket and the second basket between the loading position and the deployment position allows the system 100 to have an empty basket ready to receive the tubulars during the tubular removal operation. In another embodiment, the baskets 150 may be loaded on the carriers 125 at the same time or at different times and may be moved to (or from) the deployment position together or separately. In other words, the loading of the baskets 150 on the carriers 125 and the movement of the baskets 150 to (or from) the deployment position may have any number of different operating sequences without departing from the principles of the present invention. For instance, while a first basket is in the deployment position for unloading tubulars, a second basket may be waiting in the deployment position to unload the tubulars. Additionally, it should be noted that baskets 150 may be used for the transportation, deployment and removal of jointed solid rods, such as sucker rods, which are used for downhole oil pumps and beam pumps.

FIG. 4 is a view illustrating the basket 150 in the deployment position. As shown, the basket 150 has moved from the loading position (see FIG. 2) to the deployment position in the direction indicated by arrow 185. The carrier 125 moves the basket 150 to the deployment position upon activation of the cylinder member 110. In the deployment position, the tubulars 155 may be lifted from the basket 150 and deployed into the wellbore.

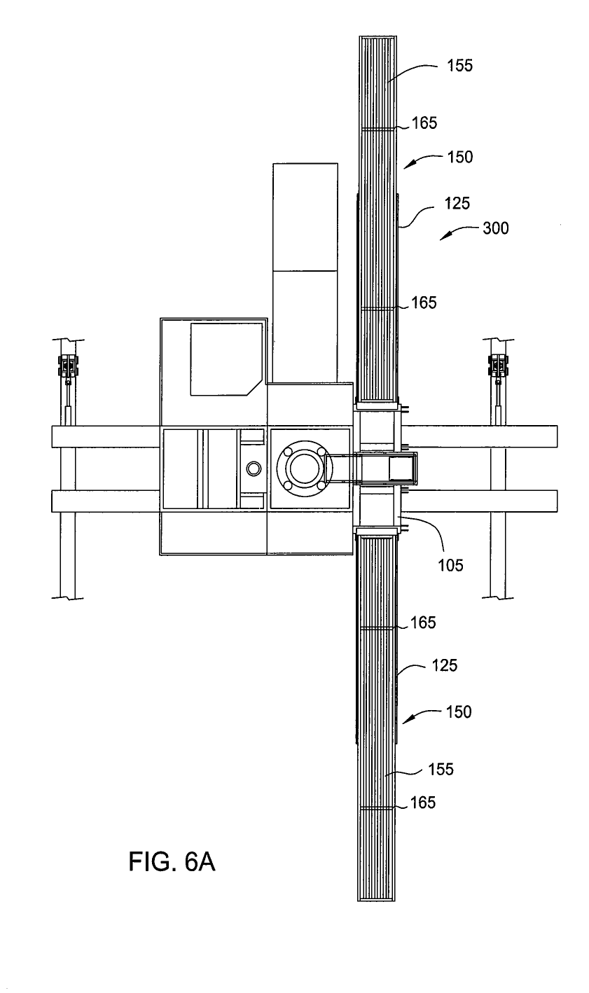

FIG. 5 is a view illustrating a tubular being removed from the basket 150. After the basket 150 is moved to the deployment position, the lifting cylinder 140 is extended in order to raise the gripping member 190 to a position where the gripping member 190 may be placed on a tubular in the basket 150. Thereafter, the lifting cylinder 140 is further extended in order to remove the tubular from the basket 150 as shown in FIG. 5. Next, the lifting cylinder 140 is retracted to allow the tubular to be connected to a tubular string in wellbore.

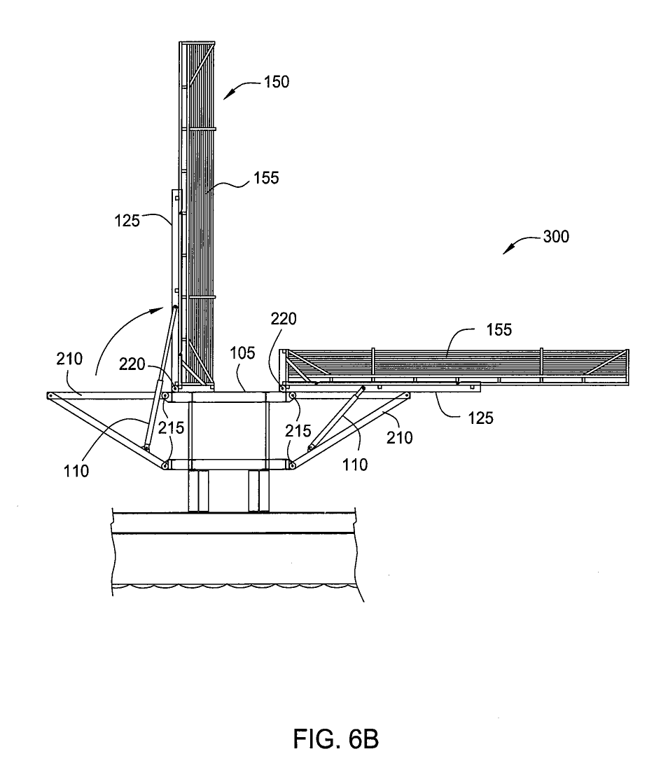

FIG. 6A is a top view and FIG. 6B is a side view illustrating a storage and deployment system 300 with two carriers 125. For convenience, the components of the system 300 that are similar to the components of the system 100 are labeled with the same reference number. As shown in FIG. 6A, the carriers 125 are positioned in series rather than parallel (see FIG. 3). This arrangement may be useful if there are components of the offshore production structure that interfere with the location and movement of the carrier 125. As previously set forth, the carrier 125 and the carrier support 210 may be detached from the rack base 105 by removing the pins 215, 220. Next, the carrier 125 and the carrier support 210 may positioned at another location on the rack base 105 and attached to the rack base 105 by reinstalling the pins 215, 220.

FIG. 6B is a side view of the system 300. The system 300 may function in a similar manner as the system 100. For instance, a first basket may be in the deployment position and second basket may be in the loading position. After the tubulars have been removed from the first basket, the empty first basket may be moved to the loading position while at the same time the second basket may be moved to the deployment position for unloading the tubulars. While the tubulars are being unloaded from the second basket, the empty first basket may be removed and replaced with a full basket. This synchronized movement of the first basket and the second basket between the loading position and the deployment position allows the system 100 to always have a basket with tubulars ready during the tubular deployment operation. Further, the tubulars may be removed from the wellbore in a tubular removal operation, as previously described. In another embodiment, the baskets 150 may be loaded on the carriers 125 at the same time or at different times and may be moved to (or from) the deployment position together or separately. In other words, the loading of the baskets 150 on the carriers 125 and the movement of the baskets 150 to (or from) the deployment position may have any number of different operating sequences without departing from principles of the present invention.

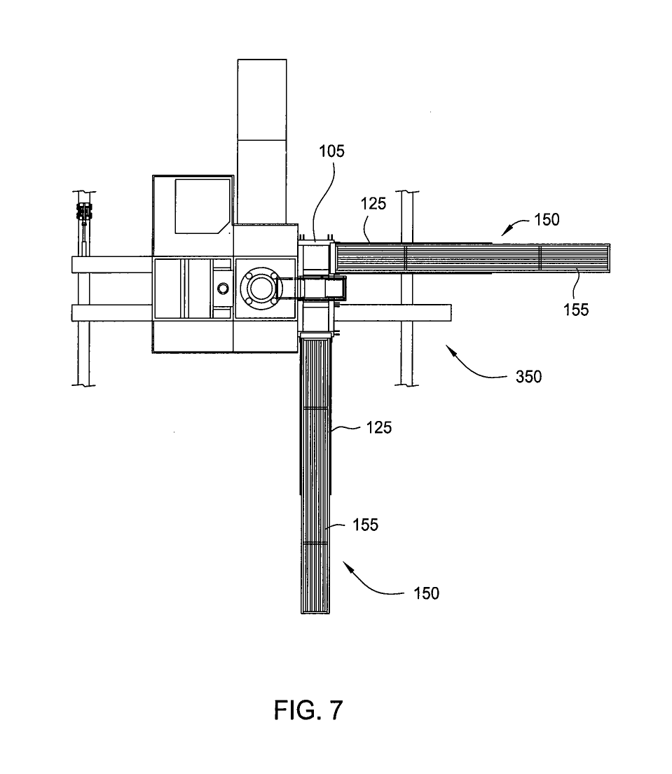

FIG. 7 illustrate a storage and deployment system 350 with one carrier positioned perpendicular to another carrier. For convenience, the components of the system 350 that are similar to the components of the system 100 are labeled with the same reference number. This arrangement may be useful if there are components of the offshore production structure that interfere with the location and movement of the carrier 125. The system 350 may be used in the tubular deployment operation and the tubular removal operation in a similar manner as described herein.

While the foregoing is directed to embodiments of the present invention, other and further embodiments of the invention may be devised without departing from the basic scope thereof, and the scope thereof is determined by the claims that follow.

1-20. (canceled)

21. A wellbore equipment deployment system, comprising:
a container configured to hold wellbore equipment; and
a container support and maneuvering system to be located adjacent a wellbore, whereby the container can be received and moved by the container support and maneuvering system to place the wellbore equipment therein operationally adjacent the wellbore.

22. The system of claim 21, wherein the wellbore equipment is wellbore tubulars.

23. The system of claim 21, wherein the wellbore equipment is downhole equipment.

24. The system of claim 21, wherein the container support and maneuvering system includes a carrier member rotatably attached to a carrier support member, the carrier member configured to receive the container.

25. The system of claim 24, wherein the container support and maneuvering system includes at least one cylinder member disposed between the carrier member and the carrier support.

26. The system of claim 25, wherein the activation of the cylinder member causes the carrier member to rotate relative to the carrier support member in order to move the container between a loading position and a deployment position.

27. The system of claim 26, wherein the container is substantially perpendicular to a longitudinal axis of the wellbore in the loading position and substantially parallel to the longitudinal axis of the wellbore in the deployment position.

28. The system of claim 21, wherein the container includes a plurality of support members arranged to form one or more sections in the container.

29. The system of claim 28, wherein the plurality of support members are attached to a bottom support and wherein a first pair of support members defines a first section and a second pair of support members defines a second section of the container.

30. The system of claim 29, wherein the container is configured to hold one size of wellbore equipment in the first section and hold another size of wellbore equipment in the second section of the container.

31. A method of deploying wellbore equipment at a wellsite, the method comprising:
placing a container support and maneuvering system adjacent a wellbore;
positioning a first container loaded with wellbore equipment on the container support and maneuvering system;
moving the first container from a loading position to a deployment position; and
removing the wellbore equipment from the first container and positioning the wellbore equipment for deployment into the wellbore.

32. The method of claim 31, further comprising positioning a second container loaded with wellbore equipment on the container support and maneuvering system.

33. The method of claim 32, further comprising moving the first container from the deployment position to the loading position when the wellbore equipment has been removed from the first container.

34. The method of claim 33, further comprising moving the second container from a loading position to a deployment position, wherein the movement of the first container and the second container are synchronized such that at least one container with wellbore equipment is in the deployment position.

35. The method of claim 34, further comprising removing the first container from the container support and maneuvering system and placing a third container having wellbore equipment on the container support and maneuvering system.

36. The method of claim 31, wherein the container includes a plurality of support members attached to a bottom support and wherein each pair of support members defines a section of the container.

37. The method of claim 36, further comprising placing one size of wellbore equipment in one section of the container and another size of wellbore equipment in another section of the container when the wellbore equipment is loaded in the container.

38. The method of claim 36, further comprising rotating the support members from a first position to a second position relative to the bottom support when wellbore equipment have been removed from one section of the container.

39. The method of claim 31, wherein the wellbore equipment is substantially parallel to a longitudinal axis of the wellbore in the deployment position.

40. A method of removing wellbore equipment from a wellbore, the method comprising:
placing a container support and maneuvering system adjacent the wellbore;
positioning a container on the container support and maneuvering system;
moving the container to a first position substantially parallel to a longitudinal axis of the wellbore;
removing the wellbore equipment from the wellbore and placing the wellbore equipment in the container; and
moving the container to a second position and removing the container with the wellbore equipment from the container support and maneuvering system.
